(19) United States
(12) Patent Application Publication
(10) Pub. No.: US 2021/0062702 A1
(43) Pub. Date: Mar. 4, 2021

(54) APPARATUS FOR CONTROLLING THE TEMPERATURE OF A FREEZABLE OPERATING/AUXILIARY MEDIUM

(71) Applicant: Robert Bosch GmbH, Stuttgart (DE)

(72) Inventors: Jan Ruigrok Van De Werve, Stuttgart (DE); Martin Kiontke, Ditzingen (DE); Mathias Schwarz, Wendlingen Am Neckar (DE); Sudeshwar Srihari, Ostfildern (DE)

(21) Appl. No.: 16/961,727

(22) PCT Filed: Nov. 30, 2018
(86) PCT No.: PCT/EP2018/083096

§ 371 Date: Jul. 13, 2020

(30) Foreign Application Priority Data
Jan. 11, 2018 (DE) 10 2018 200 317.3

(51) Int. Cl. F01N 3/20

(52) U.S. Cl. CPC F01N 3/2066; F01N 2610/1426; F01N 2610/1406; F01N 2610/10

(57) ABSTRACT

The invention relates to an apparatus for controlling the temperature of a freezable operating/auxiliary medium (12) which is stored in a reservoir (10) and is used for exhaust gas aftertreatment in compression ignition engines. An overmolding (22) on a heating element (56) forms a wall (50) of an intake duct (28) within a covering area (58).

### BACKGROUND OF THE INVENTION

The invention relates to an apparatus for controlling the temperature of a freezable operating/auxiliary medium stored in a storage tank for exhaust gas posttreatment in compression internal combustion engines.

In conventional exhaust gas posttreatment systems, which are used in particular in compression internal combustion engines, the NOₓ found in the exhaust gas is converted into H₂O and N₂ by a reducing agent. The conventional exhaust gas posttreatment systems for compression internal combustion engines operate according to the principle of selective catalytic reduction (SCR), wherein the reducing agent used is in most cases a urea-water solution, which is also known under the name AdBlue®. The exhaust gas posttreatment system comprises a storage tank, in which the freezable reducing agent is stored. The storage tank comprises a filter, possibly a filter cover, and a tank heater as three separate components. In some systems, a heat conduction pin is additionally integrated, which extends into an intake duct. During the metering, the freezable reducing agent is conveyed through a filter via the intake duct to a conveyor assembly. The filter can be attached to a carrier, wherein the filter consists of the actual filter, a filter nonwoven material, and a filter cover, which can be joined to one another in a materially-bonded manner and thus form an intake duct for a conveyor assembly. At cold temperatures below -11° C., the freezable reducing agent is thawed out in the storage tank and in the intake duct. For this purpose, a tank heater associated with the storage tank is fastened locally on small surfaces on the filter cover to represent a heat transfer from the tank heater to the intake duct. In addition, a heat conduction pin made of particularly heat-conductive material, thus, for example, stainless steel, is integrated into the filter cover of the filter in the storage tank to enable an additional heat transfer from the heater via the reducing agent in the storage tank via the heat conduction pin into the intake duct.

In exhaust gas posttreatment systems which are already in operation, the tank heater is joined to the filter on small surfaces. A separation thus results between the heating element of the tank heater and the intake duct, which are both separated from one another by insulating reducing agent. Hardly any heat transfer is thus possible from the tank heater to the frozen reducing agent in the intake duct. To remedy this disadvantage, an additional element, namely a heat conduction pin, generally made of stainless steel, is used so that the tank heater firstly thaws a part of the reducing agent in the storage tank and subsequently heat is emitted from this heated reducing agent to the heat conduction pin, which in turn conducts the heat to the intake duct and thaws the frozen reducing agent therein. This solution results in sluggish thawing behavior, furthermore an additional element in the form of the heat conduction pin made of stainless steel is required, furthermore relatively high thermal resistances are represented in total, which do not assist the thawing behavior with frozen reducing agent. Furthermore, the production or the creation of material bonds between the components is quite complex.

### SUMMARY OF THE INVENTION

According to the invention, an apparatus is proposed for controlling the temperature of a freezable operating/auxiliary medium stored in the storage tank for exhaust gas posttreatment in compression internal combustion engines, in which an extrusion coating of a heating element inside an overlap region forms an intake duct wall of an intake duct. The thermal resistance between the heating element and the intake duct is significantly reduced by the solution proposed according to the invention. Frozen operating/auxiliary medium located in the intake duct can thus be thawed out faster, wherein the additional element previously used to improve the heat transfer in the form of a relatively costly heat conduction pin made of stainless steel can be omitted. In comparison to the solution according to the prior art, the chain of thermal resistances is significantly shorter, which results in a significant acceleration of the thawing behavior using the apparatus proposed according to the invention for controlling the temperature of a freezable operating/auxiliary medium.

In one refinement of the solution proposed according to the invention, the intake duct is delimited by the extrusion coating of the heating element, on the one hand, and, on the other hand, either by a filter housing or a carrier on the storage tank.

The apparatus proposed according to the invention for controlling the temperature of a freezable operating/auxiliary medium stored in a storage tank is designed in such a way that the extrusion coating of the heating element has a reduced wall thickness in the overlap region. Overlap region is to be understood in the present context as the region over which the heating element extends in parallel to the intake duct. If the wall thickness of the extrusion coating of the heating element, which simultaneously forms the delimitation wall of the intake duct, is reduced in this region, the thermal resistance between the heating element and the intake duct may thus be reduced once again, whereby a further acceleration of the thawing procedure can be achieved.

In the solution proposed according to the invention, the thermal resistance between the heating element and the intake duct is exclusively influenced by the thermal resistance of the material of the extrusion coating of the heating element. The previously typical extrusion coating material, thus, for example, HDPE and ETFE can be replaced in this case by a plastic material which is filled using glass fiber or using boron nitride, to further reduce the thermal resistance of the plastic extrusion coating of the heating element. In principle, low-temperature-resistant thermoplastic materials are suitable, which have a very strong permeation barrier against the operating/auxiliary medium and its decomposition products, which are also gaseous decomposition products such as NH3. In addition, good heat conduction properties are advantageous.

Therefore, unfilled HDPE and ETFE materials and the derivatives thereof are preferably also suitable. As further alternatives, diverse filler materials can be admixed to the mentioned materials to increase the thermal conductivity, for example, boron nitride or aluminum oxide.

According to the solution proposed according to the invention, the heating element enclosed by the extrusion coating replaces a filter cover and thus makes an additional component otherwise required obsolete.

If the solution proposed according to the invention is used, a filter nonwoven material can additionally be used which extends essentially in the intake region of the intake duct in the storage tank. This filter nonwoven material can be placed in such a way that it is wetted on its upper side and on its lower side by the freezable operating/auxiliary material stored in the storage tank.

The heating element used in the apparatus proposed according to the invention having an extrusion coating made of a plastic material essentially overlaps the entire intake duct and also the intake region in the storage tank located in front of the intake duct. Due to the special geometrical shaping of the tank heater in a flat construction, relatively large regions in the storage tank can thus be heated in the region of the intake duct and in the intake region upstream from it, which in particular takes place simultaneously, whereby in consideration of the reduced thermal resistance in comparison to the previous solutions, significantly faster thawing behavior of the freezable operating/auxiliary medium may be achieved at temperatures of less than −11° C.

In the production of the apparatus proposed according to the invention for controlling the temperature of the freezable operating/auxiliary medium, it is to be emphasized that a first materially-bonded joint is embodied as a circumferential welded seam.

The invention additionally relates to the use of the apparatus for controlling the temperature of a freezable operating/exhilarating medium stored in a storage tank for exhaust gas posttreatment in compression internal combustion engines.

The apparatus proposed according to the invention for controlling the temperature of a freezable operating/auxiliary medium in exhaust gas posttreatment systems is distinguished in that due to the shaping of the heating element including its extrusion coating, this component may be used as a replacement of a previously used filter cover. One component can thus be saved, as well as the heat conduction pin used in previous solutions, which represents a particularly expensive component since it is made of stainless steel. Due to the reduction of the thermal resistances between the heater and the intake duct with corresponding formation of the extrusion coating in the least possible wall thickness, significantly faster thawing of frozen operating/auxiliary medium is achieved by the apparatus proposed according to the invention both in the lower region of the storage tank and also in particular in the intake duct connected upstream of the conveyor assembly feed. In comparison to the solutions from the prior art, the thermal resistance between the heater and the intake duct is reduced and limited to one wall made of plastic material.

In a manufacturing aspect, it is to be emphasized that due to fewer components, joints can also be omitted, thus, for example, welded interfaces. Not only the thermal resistance in the meaning of heat conduction is reduced by the solution proposed according to the invention, but rather also the undesired cooling of the intake duct taking place due to the operating/auxiliary medium. This undesired cooling occurs if operating/auxiliary medium is located between the heater and the intake duct, still in the tank but not in the filter, this operating/auxiliary medium thus sloshes during driving into the intake duct. Already thawed operating/auxiliary medium is thus removed between heater and intake duct, which takes place due to draining. This has the result that operating/auxiliary medium is thawed which is irrelevant for the metering readiness, on the other hand, due to the occurring fluid flow, the intake duct is cooled at a critical point, since energy is withdrawn.

The solution proposed according to the invention enables a contact between heater and target, the intake duct, without an additional heat conduction component being necessary.

Furthermore, the solution proposed according to the invention offers a possible combination of filter and heater, since the filter nonwoven material is integrated into the heater. A further reduction of the thermal resistance chain in the filter interior thus takes place, furthermore an installation space reduction may be achieved by omitting air gaps, which in turn enables installation clearance, on the other hand. Due to the solution proposed according to the invention, a simplification of the installation takes place with combined filter and heater, as well as a cost reduction accompanying this.

### BRIEF DESCRIPTION OF THE DRAWINGS

The invention is described in greater detail hereinafter on the basis of the drawings.

In the figures:

FIG. 1 shows a configuration of a heater and an intake duct,

FIG. 2 shows the thermal resistances resulting from this arrangement,

FIG. 3 shows a top view of an apparatus, wherein the heating element designed in a flat construction is not shown,

FIG. 4 shows a section through the apparatus according to FIG. 3 along section line IV-IV shown in FIG. 3, and

FIG. 5 shows the thermal resistance resulting in the proposed solution between the temperature of the heating unit and the temperature of the intake duct.

### DETAILED DESCRIPTION

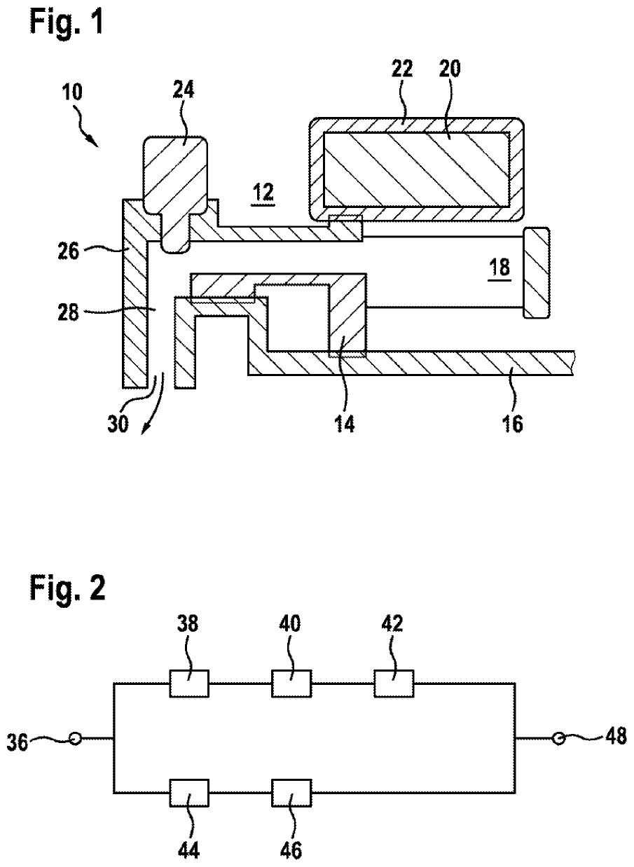

A storage tank 10, in which a freezable operating/auxiliary medium 12, which is preferably a reducing agent, is accommodated, is apparent in the illustration according to FIG. 1. The freezable operating/auxiliary medium freezes at a temperature of less than −11° C. As FIG. 1 shows, a filter 14 is connected upstream of an intake duct 28. The filter 14 can be accommodated on a carrier 16 and can comprise a filter nonwoven material 18. A heating element/cooling element 20, which is enclosed by an extrusion coating 22, which is generally made of a plastic material, is located above the filter 14. In addition, a heat conduction pin 24, which is made of stainless steel, for example, is located in a filter cover 26. A conveyor assembly feed 30 extends out from the intake duct 28 to a conveyor assembly (not shown in FIG. 1).

In the solution according to FIG. 1, the thermal resistances illustrated in FIG. 2 result. As is apparent from the schematic illustration according to FIG. 2, a first thermal resistance 38 of the extrusion coating and a second thermal resistance 40 exist between the Theater, 36 and the temperature 48, TunaIce duct, prevailing in the intake duct, wherein the second thermal resistance 40 is particularly critical, since it is defined in the best case by the operating/auxiliary medium and in the worst case at low fill levels by air. The second thermal resistance 40 thus rises significantly. In addition, dynamic influences, for example, the movement of the operating/auxiliary material (sloshing movements) can come to bear, which represent a continuous energy loss due to flowing away of the heated operating/auxiliary medium. Furthermore, a further thermal resistance 42 is given by the heat conduction pin 24. Finally, a second thermal resistance 46 exists, also caused by the extrusion coating 22, and also a thermal resistance 46 which is caused by the presence of the filter cover 26.

### Embodiment Variants

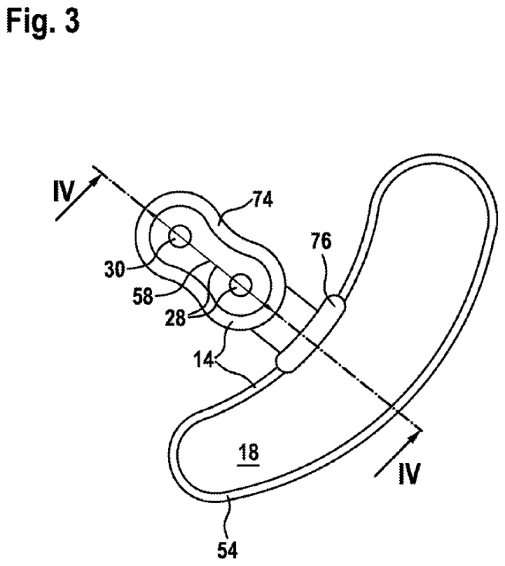

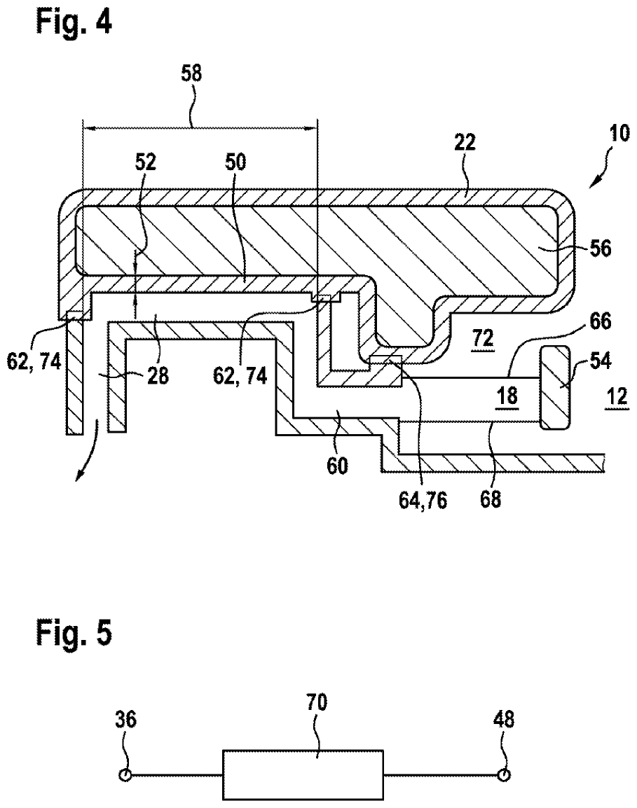

FIG. 3 shows a partial view of an apparatus proposed according to the invention for controlling the temperature of a freezable operating/auxiliary medium 12 stored in a storage tank 10. In the top view according to FIG. 3, a heating element 56 embodied essentially in a flat construction, which overlaps the components illustrated in FIG. 3, is not shown. It is apparent from the top view according to FIG. 3 that the filter nonwoven material 18, enclosed by a filter edge 54, extends in a crescent shape in front of the intake duct 28 in the intake region 72 (cf. illustration according to FIG. 4). The conveyor assembly feed 30 extends from the intake duct 28 perpendicularly to the plane of the drawing according to FIG. 3. Reference numerals 74 and 76 respectively identify first and second materially bonded joints, which are used as connection points 62, 64, cf. FIG. 4, between the actual heating element 56 in flat construction or its extrusion coating 22 and the further components of the storage tank.

FIG. 4 shows a section through the apparatus proposed according to the invention along section line Iv-Iv shown in FIG. 3.

As is apparent from the section according to FIG. 4, the heating element 56 designed in flat construction is enclosed by an extrusion coating 22, which is generally made of plastic material. The extrusion coating 22 has multiple functions. On the one hand, the extrusion coating 22 of the heating element 56 designed in flat construction is used for encasing and protecting the heating element 56 against the medium surrounding it, i.e., the freezable operating/auxiliary medium 12. As is apparent from FIG. 4, the heating element 56 designed in flat construction and enclosed by the extrusion coating 22 is fastened at connection points 62, 64, which are embodied as materially bonded joints 74, 76, above the intake duct 28 and above the filter nonwoven material 18. The heating element 56 designed in flat construction is provided here such that the heating element 56 or the extrusion coating 22 extends along an overlap region 58 along the intake duct 28. It is apparent from FIG. 4 that a part of the extrusion coating 22 of the heating element 56 designed in flat construction is used as an intake duct wall 50. To minimize its thermal resistance 70 as much as possible, the extrusion coating 22 can be embodied in a reduced wall thickness 52 in the region in which the intake duct wall of the intake duct 28 is formed. The resulting thermal resistance 70 during the heat transfer from the heating element 56 to the frozen operating/auxiliary medium 12 collected in the intake duct 28 will thus be reduced still further. The geometry of the extrusion coating or the heating element is furthermore provided such that it also overlaps an intake region 72. The intake region 72, via which the operating/auxiliary medium 12 stored in the tank flows to the filter nonwoven material 18, is located on its upper side 66. As is apparent from the section according to FIG. 4, the filter nonwoven material 18, stabilized by the filter edge 54, is wetted from its upper side 66 and also its lower side 68. Due to the selected geometry of the heating element 56 designed in flat construction and the extrusion coating 22 surrounding it, the intake region 72, which is upstream of the intake duct 28 in the storage tank, can also be heated.

An inflow curve formed in the intake duct 28 is identified by reference numeral 60, which extends from the filter nonwoven material 18 to the section of the intake duct 28, within which the extrusion coating 22 of the heating element 56 designed in flat construction creates the intake duct wall 50. The length of this section corresponds to the overlap region 58.

FIG. 5 shows a thermal equivalent circuit diagram, according to which only the thermal resistance 70 of the extrusion coating 22 is to be overcome between Theater 36 of the heating element 56 designed in flat construction and the intake duct temperature 48. This resistance is clearly minimized in comparison to the solution shown in FIG. 2, as a comparison to the illustration according to FIG. 2 shows, so that the thawing speed of the apparatus proposed according to the invention is significantly shorter, as described above.

The solution proposed according to the invention is distinguished by an avoidance of uncontrollable thermal resistances, as can be induced, for example, due to sloshing movements of the operating/auxiliary medium or by air. According to the solution proposed according to the invention, all thermal resistances are given by solid body contact and are therefore well-defined.

The invention is not restricted to the exemplary embodiments described here and the aspects highlighted therein. Rather, a variety of modifications is possible within the scope specified by the claims, which are in the scope of routine measures in the art.

1. An apparatus for controlling the temperature of a freezable operating/auxiliary medium (12) stored in a storage tank (10) for exhaust gas posttreatment in compression internal combustion engines, the apparatus comprising an intake duct wall (50) of an intake duct (28) formed by an extrusion coating (22) of a heating element (56) within an overlap region (58).

2. The apparatus for controlling the temperature as claimed in claim 1, characterized in that the intake duct (28) is delimited by the extrusion coating (22) of the heating element (56) and by a filter (14) or a carrier (16).

3. The apparatus for controlling the temperature as claimed in claim 1, characterized in that the extrusion coating (22) of the heating element (56) has a reduced wall thickness (52) in the overlap region (58).

4. The apparatus for controlling the temperature as claimed in claim 1, characterized in that a thermal resistance between the heating element (56) and the intake duct (28) is only provided by the thermal resistance (70) of the extrusion coating (22) of the heating element (56).

5. The apparatus for controlling the temperature as claimed in claim 1, characterized in that the heating element (56) enclosed by the extrusion coating (22) replaces a filter cover (26).

6. The apparatus for controlling the temperature as claimed in claim 1, characterized in that a filter nonwoven material (18), which is wetted on an upper side (66) and on a lower side (68) by operating/auxiliary medium (12), is accommodated in the intake region (72) of the intake duct (28).

7. The apparatus for controlling the temperature as claimed in claim 1, characterized in that the heating element (56) having extrusion coating (22) overlaps both the intake duct (28) and also the intake region (72) located in front of the intake duct (28) in the storage tank (10).

8. The apparatus for controlling the temperature as claimed in claim 1, characterized in that a first materially-bonded joint (74) is embodied as a circumferential weld seam between the heating element 56 or the extrusion coating 22 and further components of the storage tank (10).

9. The apparatus for controlling the temperature as claimed in claim 3, characterized in that the reduced wall thickness (52) of the extrusion coating (22) within the overlap region (58) is between 1 mm and 2 mm and the intake duct (28) extends essentially along a flat heating element (56).

10. (canceled)

11. A method for thawing a freezable operating/auxiliary medium (12) in an exhaust gas posttreatment system of compression internal combustion engines, the method comprising using the apparatus as claimed in claim 1.
